(19) United States
(12) Patent Application Publication
(10) Pub. No.: US 2005/0277541 A1
(43) Pub. Date: Dec. 15, 2005

(54) Sealing glass frit

(75) Inventors: Tetsuro Yoshii, Tsukuba-shi (JP); Hiroshi Nishikawa, Tokyo (JP)

Correspondence Address: COHEN, PONTANI, LIEBERMAN & PAVANE, Suite 1210, 551 Fifth Avenue, New York, NY, 10176, US

(73) Assignee: Nippon Sheet Glass Company, Limited, Tokyo (JP)

(21) Appl. No.: 11/099,922

(22) Filed: Apr. 6, 2005

Related U.S. Application Data
(63) Continuation of application No. PCT/JP03/12218, filed on Sep. 25, 2003.

(30) Foreign Application Priority Data
Oct. 7, 2002 (JP) 2002-294053

(51) Int. Cl. C03C 8/24; C03C 8/04

(52) U.S. Cl. 501/26; 501/69; 501/15

(57) ABSTRACT

A sealing glass frit which is capable of stably joining metal members or ceramic members at temperatures thereof not higher than 1000° C., and at the same time stably maintaining the joined state of the members at temperatures ranging from room temperature to 700 or 800° C. A raw material in an amount of MG 300 g is prepared such that it has a composition of 40 to 70 mol % of SiO₂, 5 to 20 mol % of Al₂O₃, 4 to 20 mol % of Na₂O, 4 to 20 mol % of K₂O, 5 to 20 mol % of ZnO, and 0.5 to 5 mol % of ZrO₂, and the total content of Na₂O and K₂O is not lower than 12 mol %. The raw material is melted in a platinum crucible at 1550° C. for 8 hours, cast in a mold of stainless steel, held at 650° C. for 2 hours, and then cooled to room temperature at 5° C./minute. The cooled raw material is pulverized in a mortar to obtain powder having a particle diameter 10 to 20 μm as a sealing glass frit.

### TECHNICAL FIELD

The present invention relates to a sealing glass frit.

### BACKGROUND ART

In manufacturing composites composed of ceramic members and metal members, sealing glass frits are widely used as joining materials for joining the ceramic members and the metal members into the composites. A known method of manufacturing a sealing glass frit comprises first mixing a plurality of kinds of inorganic materials with each other so as to obtain a mixture having a composition suitable for the intended use, melting the mixture at a high temperature to prepare a melt uniform in composition ratio, cooling the melt to obtain a glass composition, pulverizing the obtained glass composition into glass powder, and mixing an additive, such as a filler (a filler containing inorganic crystals) into the glass powder, as required.

Further, a known method of manufacturing a composite comprises forming sealing a glass frit obtained as described above into paste, for example, then applying the glass frit to a ceramic member, softening the glass frit at a high temperature to thereby cause the same to be fusion-bonded to the ceramic member, joining a metal member to the ceramic member via the fusion-bonded sealing glass frit, and cooling the members joined via the sealing glass frit.

Typical sealing glass frits conventionally used include ones based on B₂O₃ or P₂O₅ for use in a low-temperature range thereof below 600° C., and ones using a crystallized glass for use in a high-temperature range thereof not lower than 1000° C.

Further, recently, there is an increasing demand for composites to be used as component members of high-temperature equipment or the like which operates at temperatures in a range of 700 to 800° C. and close to the range. As a sealing glass frit that meets the requirement, there has been proposed one which is mechanically and chemically stable at the above-mentioned operating temperatures and temperatures close thereto (see e.g. Japanese Laid-Open Patent Publication (Kokai) No. 2000-63146).

However, the high-temperature equipment or the like cools to room temperature when it is not in operation, and therefore it is difficult to stably maintain a sealed state of component members used in the high-temperature equipment or the like, unless the sealing glass frit used is capable of stably joining metal members and ceramic members to each other at temperatures ranging from room temperature to approximately the operating temperature of the high-temperature equipment or the like. Therefore, even if the sealing glass frit used is mechanically and chemically stable at the operating temperature of the high-temperature equipment or the like and a temperature close thereto, this property of the sealing glass frit is not sufficient for stably maintaining the sealed state of the component members employed in the high-temperature equipment or the like.

On the other hand, the conventional sealing glass frits based on B₂O₃ or P₂O₅ for use in the low-temperature range below 600° C. become softened at 800° C. or temperatures close thereto, and therefore it is difficult for the glass frits to stably maintain the sealed state at temperatures in a range of 700 to 800° C. and close to the range.

Further, although also conventionally used, the sealing glass frits using a crystallized glass for use in the high-temperature range not lower than 1000° C. are largely changed in the expansion ratio of the crystallized glass depending on the degree of crystallization occurring in an operating temperature range thereof, and therefore, when a large area is sealed, it is difficult to stably maintain the sealed state of the area due to occurrence of variation in the expansion ratio of the glass frit in the area.

It is an object of the present invention to provide a sealing glass frit which is capable of stably joining metal members and ceramic members at temperatures thereof not higher than 1000° C., and at the same time capable of stably maintaining their sealed state at temperatures ranging from room temperature to 700 or 800° C.

### DISCLOSURE OF THE INVENTION

To attain the above object, the present invention provides a sealing glass frit for joining metal members or ceramic members, comprising, as essential components, SiO₂: 40 to 70 mol %, Al₂O₃: 5 to 20 mol %, Na₂O: 4 to 20 mol %, K₂O: 4 to 20 mol %, ZnO: 5 to 20 mol %, and ZrO₂: 0.5 to 5 mol %, and wherein the total content of Na₂O and K₂O is not lower than 12 mol %.

Preferably, the sealing glass frit comprises SiO₂: 55 to 65 mol %, Al₂O₃: 5 to 12 mol %, Na₂O: 4 to 20 mol %, K₂O: 4 to 20 mol %, ZnO: 5 to 15 mol %, ZrO₂: 0.5 to 3 mol %, and CoO: 0 to 3 mol %, and wherein the total content of Na₂O and K₂O is not lower than 15 mol %.

Preferably, Li₂O: 0 to 5 mol %, MgO: 0 to 5 mol %, CaO: 0 to 5 mol %, SrO: 0 to 5 mol %, BaO: 0 to 5 mol %, TiO₂: 0 to 5 mol %, B₂O₃: 0 to 5 mol %, and CoO: 0 to 5 mol % are added to the essential components such that a total content thereof is not higher than 10 mol %. More preferably, the total content of MgO, CaO, SrO, and BaO is not higher than 4 mol %.

Preferably, the molar ratio of Na₂O to K₂O is in a range of 2.0 to 4.0.

Alternatively, the molar ratio of Na₂O to K₂O is in a range of 0.5 to 2.0.

Preferably, the total content of Na₂O and K₂O is not lower than 15.5 mol %.

Preferably, the temperature of the sealing glass frit at a yield point thereof is not lower than 640° C.

Preferably, 0.1 to 10 mass % of at least one material selected from the group consisting of alumina, cordierite, silica, zircon, aluminum titanate, forsterite, mullite, β-eucryptite, and β-spodumene is added as a filler.

### BRIEF DESCRIPTION OF DRAWINGS

FIG. 1 is a schematic view showing component elements of a solid oxide fuel cell, joined to each other by a sealing glass frit according to an embodiment of the present invention; and

FIG. 2 is a perspective view showing a stainless steel substrate and a ring used for measuring the fusion-bonding property of a sealing glass frit for evaluation thereof.

### BEST MODE FOR CARRYING OUT THE INVENTION

A description will now be given of the functions of components constituting a sealing glass frit according to an embodiment of the present invention.

SiO₂ is a main component used in manufacturing glass. When the SiO₂ content is less than 40 mol %, vitrification does not occur, whereas when the SiO₂ content is more than 70 mol %, sufficient fusion bonding cannot be attained even at a temperature of 1100° C.

Al₂O₃ is an essential component for maintaining the rigidity of the sealing glass frit at temperatures in a range of 700 to 800° C. and close to the range. When the Al₂O₃ content is less than 5 mol %, sufficient rigidity cannot be obtained at temperatures in a range of 700 to 800° C. and close to the range, whereas when the Al₂O₃ content is more than 20 mol %, devitrification is liable to occur during fusion bonding.

Na₂O is an essential component for adjusting the expansion ratio and fusion-bonding temperature of the sealing glass frit. When the Na₂O content is less than 4 mol %, the sealing glass frit has an expansion ratio of less than 90×10⁻⁷/° C. at temperatures not higher than 1000° C., and cannot be sufficiently fusion-bonded to metal members and ceramic members even at 1100° C. or temperatures close thereto, whereas when the Na₂O content is more than 20 mol %, the sealing glass frit cannot maintain its rigidity at 800° C. and temperatures close thereto.

K₂O, similarly to Na₂O, is an essential component for adjusting the expansion ratio and fusion-bonding temperature of the sealing glass frit. When the K₂O content is less than 4 mol %, the sealing glass frit has an expansion ratio of less than 90×10⁻⁷/° C. at temperatures not higher than 1000° C., and cannot be sufficiently fusion-bonded to the metal members and the ceramic members even at 1100° C. or temperatures close thereto, whereas when the K₂O content is more than 20 mol %, the sealing glass frit cannot maintain its rigidity at 800° C. or temperatures close thereto.

Further, when the total content of Na₂O and K₂O is not lower than 15 mol %, it is possible to maintain an expansion ratio of not smaller than 90×10⁻⁷/° C. at temperatures ranging from room temperature to 700 or 800° C. When the total content of Na₂O and K₂O is not lower than 15.5 mol %, it is possible to maintain an expansion ratio of not smaller than 90×10⁻⁷/° C. at temperatures ranging from room temperature to 700 or 800° C. Further, when the mol % ratio of the Na₂O content to the K₂O content is in a range of 0.5 to 2.0, devitrification is difficult to occur. On the other hand, when the mol % ratio of the Na₂O content to the K₂O content is in a range of 2.0 to 4.0, K₂CrO₄ is difficult to be generated even when K₂O reacts with Cr in the metal members. The melting point of K₂CrO₄ is 975° C. and hence higher than 800° C., which increases the possibility of a joined portion separating due to generation of K₂CrO₄.

ZnO is an essential component for lowering the fusion-bonding temperature of the sealing glass frit while maintaining rigidity thereof at 700 to 800° C. When the ZnO content is less than 5 mol %, such effects cannot be obtained, and when the same is more than 20 mol %, devitrification is liable to occur during fusion bonding.

ZrO₂ is an essential component for lowering the fusion-bonding temperature of the sealing glass frit while maintaining rigidity thereof at 700 to 800° C. When the ZrO₂ content is less than 0.5 mol %, such effects cannot be obtained, and when the same is more than 5 mol %, devitrification is liable to occur during fusion bonding.

Further, when the sealing glass frit is composed of the above essential components, i.e. SiO₂: 40 to 70 mol %, Al₂O₃: 5 to 20 mol %, Na₂O: 4 to 20 mol %, K₂O: 4 to 20 mol %, ZnO: 5 to 20 mol %, and ZrO₂: 0.5 to 5 mol %, and the total content of Na₂O and K₂O is not lower than 12 mol %, the viscosity of the sealing glass frit at 1000° C. can be made not higher than 10000 P which is suitable for fusion bonding. This makes it possible to stably join the metal members and the ceramic members at temperatures not higher than 1000° C. Further, by configuring the sealing glass frit having the above described composition such that the mean expansion ratio thereof at temperatures ranging from room temperature to a temperature lower than its transition point by 30° C. is not smaller than 90×10⁻⁷/° C. to make the expansion ratio of the sealing glass frit closer to those of the metal members and the ceramic members, it is possible to stably maintain the joined state of the metal members and the ceramic members at temperatures ranging from room temperature to 700 or 800° C.

Further, when the described above sealing glass frit is composed of SiO₂: 55 to 65 mol %, Al₂O₃: 5 to 12 mol %, Na₂O: 4 to 20 mol %, K₂O: 4 to 20 mol %, ZnO: 5 to 15 mol %, ZrO₂: 0.5 to 3 mol %, and CoO: 0 to 3 mol %, and the total content of Na₂O and K₂O is not lower than 15 mol %, it is possible to maintain a stable joined state even if the sealing glass frit is held at 700 to 800° C.

Further, when Li₂O: 0 to 5 mol %, MgO: 0 to 5 mol %, CaO: 0 to 5 mol %, SrO: 0 to 5 mol %, BaO: 0 to 5 mol %, TiO₂: 0 to 5 mol %, B₂O₃: 0 to 5 mol %, and CoO: 0 to 5 mol % are added to the sealing glass frit described above such that the total content thereof is not higher than 10 mol %, it is possible to lower the fusion-bonding temperature of the sealing glass frit while maintaining rigidity thereof at temperatures up to 700 or 800° C., and when the total content of MgO, CaO, SrO, and BaO is not higher than 4 mol %, it is possible to make devitrification difficult to occur at temperatures ranging from room temperature to 700 or 800° C.

Although Li₂O, MgO, CaO, SrO, BaO, TiO₂, B₂O₃, and CoO are not essential components, when the total content thereof in the glass frit exceeds 10 mol %, devitrification is liable to occur.

Further, by using Li₂O in combination with Na₂O and K₂O, it is possible to adjust the expansion ratio and fusion-bonding temperature of the sealing glass frit. However, when the Li₂O content in the sealing glass frit exceeds 5 mol %, it becomes impossible to maintain the rigidity of the glass frit at 800° C. and temperatures close thereto.

Furthermore, alkali metal oxides, such as MgO, CaO, SrO, and BaO, can be used as adjusting components for lowering the fusion-bonding temperature of the sealing glass frit while maintaining the rigidity of the glass frit at 700 to 800° C. However, when the total content of the above mentioned components is higher than 5 mol %, devitrification is liable to occur during fusion bonding. Further, when the total content of MgO, CaO, SrO, and BaO is higher than 4 mol %, devitrification is liable to occur at temperatures ranging from room temperature to 700 or 800° C.

Further, TiO₂ acts to enhance the fusion-bonding property of the sealing glass frit while maintaining the rigidity of the glass frit at 700 to 800° C. However, when the TiO₂ content is higher than 5 mol %, the expansion ratio of the sealing glass frit becomes smaller than 90×10⁻⁷/° C., and furthermore devitrification is liable to occur during fusion bonding.

B₂O₃ can improve wettability between the sealing glass frit and the ceramic members or between the sealing glass frit and the metal members. However, when the B₂O₃ content is higher than 5 mol %, it is impossible to maintain the shape stability of the sealing glass frit when the sealing glass frit held is held at 700 to 800° C.

CoO can improve the fusion-bonding property of the sealing glass frit to the ceramic members and the metal members, if CoO is contained in an appropriate amount in glass forming the sealing glass frit. However, when the CoO content is higher than 5 mol %, devitrification is liable to occur during fusion bonding. Although CoO is a transition metal oxide effective for improving the fusion-bonding property, V₂O₅, Cr₂O₃, MnO₂, Fe₂O₃, NiO₂, CuO, Nb₂O₃, Mo₂O₅, Ta₂O₅, Bi₂O₃, and lanthanoid-based transition metal oxides as well can provide the effect of effectively improving the fusion-bonding property, depending on the kinds of ceramic members and metal members to which the sealing glass frit is fusion-bonded.

Still further, when the temperature of the sealing glass frit at the yield point is made not lower than 640° C., the sealing glass frit can maintain rigidity thereof in a temperature range of 700 to 800° C.

Further, when 0.1 to 10 mass % of at least one material selected from the group consisting of alumina, cordierite, silica, zircon, aluminum titanate, forsterite, mullite, β-eucryptite, and β-spodumene is added to the aforementioned components as a filler, it is possible to properly adjust the expansion ratio of the sealing glass frit.

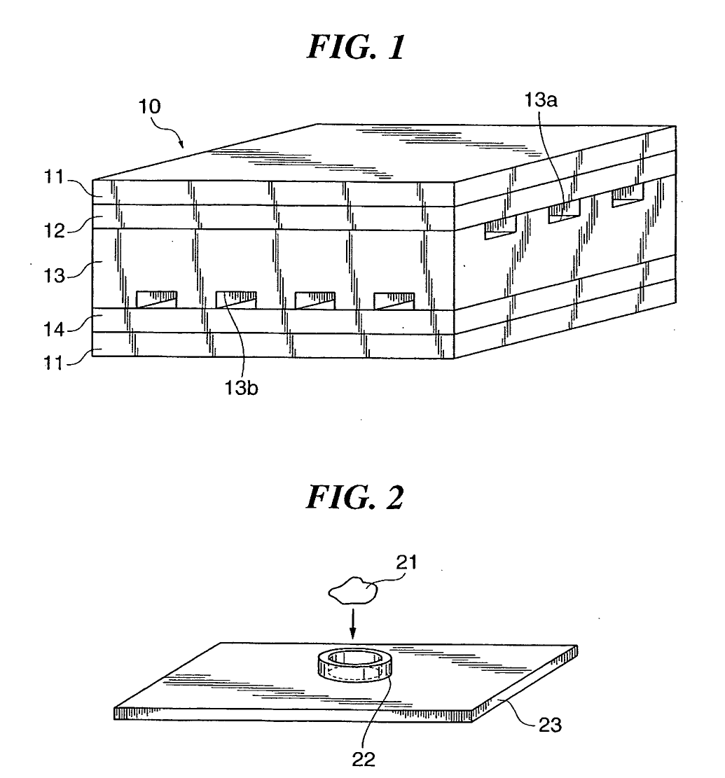

The metal members and the ceramic members, referred to hereinabove, are component elements e.g. of a solid oxide fuel cell, described hereinafter with reference to FIG. 1. When the sealing glass frit is used to join the component elements, it is possible to increase the service life of the solid oxide fuel cell.

FIG. 1 is a view schematically showing the component elements of the solid oxide fuel cell, joined to each other by an sealing glass frit according to an embodiment of the present invention.

In FIG. 1, the solid oxide fuel cell 10 is comprised of a cathode 12 formed of YSZ (yttria-stabilized zirconia)/Ni cermet, a separator 13 formed of a Ni—Cr alloy, an anode 14 formed of (La, Sr) MnO₃, and electrolytes 11 formed of YSZ for sandwiching a laminate formed by sequentially disposing the cathode 12, the separator 13, and the anode 14.

The separator 13 includes an air diffusion layer 13a formed with grooves for passing O₂ to the cathode 12, and a fuel diffusion layer 13b formed with grooves for passing H₂, CO, and CH₄ to the anode 14.

The separator 13, and each of the cathode 12 and the anode 14 are joined to each other by the sealing glass frit described above. When the electrolytes 11 are heated to a temperature not lower than an operating temperature of e.g. 750° C., the electrolytes 11 exhibit ionic conductivity to serve as electrolytes. The cathode 12 and the anode 14 are connected together via electric wires.

In the solid oxide fuel cell 10 described above, H₂, CO, and CH₄ passing through the fuel diffusion layer 13b, and O₂ passing through the separator 13 to be supplied to the fuel diffusion layer 13b undergo an oxidation reaction in the electrolyte 11 toward the anode 14, to thereby generate H₂O and CO₂. Simultaneously with the oxidation reaction, electrons are liberated to move to the anode 14. The electrons having moved to the anode 14 are supplied to the cathode 12 via the electric wire connected to the anode 14.

On the other hand, O₂ passing through the air diffusion layer 13a undergoes a reduction reaction in the electrolyte 11 toward the cathode 12, to thereby generate O₂—. The O₂ passes through the separator 13 to be supplied to the fuel diffusion layer 13b.

As described above, when in operation, the solid oxide fuel cell 10 is normally heated to the operating temperature of 750° C. so as to cause the electrolytes 11 to exhibit ionic conductivity, whereas when not in operation, the solid oxide fuel cell 10 is allowed to cool down to room temperature. Thus, the temperature of the solid oxide fuel cell 10 varies between the operating temperature and room temperature. This is why the sealing glass frit described above is used to join the metal members and the ceramic members so as to stably maintain the joined state of the metal members and the ceramic members at temperatures not higher than 750° C., which members were joined at 1000° C. or temperatures close thereto.

According to the embodiment of the present invention, the sealing glass frit made of glass having the above described composition is used to join the cathode 12, the separator 13, and the anode 14, which constitute the solid oxide fuel cell 10, to each other. As a result, it is possible to increase the service life of the solid oxide fuel cell 10.

The use of the sealing glass frit according to the present invention is by no means limited to the solid oxide fuel cell 10, but it is to be understood that the sealing glass frit may be used for any use in which the sending glass frit is required to stably join metal members and ceramic members to each other at temperatures not higher than 1000° C., and further be capable of preventing separation of the joined members or the like when the temperature of the joined members is varied from room temperature to 700 or 800° C.

### EXAMPLES

### Examples of the present invention will now be described.

Raw materials in an amount of MG 300 g were mixed into compositions shown in Table 1 and Table 2, and the mixtures were melted in a platinum crucible at 1550° C. for 8 hours. Then, each melt was cast in a mold of stainless steel, held at 650° C. for 2 hours, and then cooled to room temperature at 5 C/minute.

TABLE 1

| | Examples | | | | | | | | | | |
|---|---|---|---|---|---|---|---|---|---|---|---|
| | 1 | 2 | 3 | 4 | 5 | 6 | 7 | 8 | 9 | 10 | 11 |
| SiO₂ (mol %) | 60.3 | 59.0 | 55.0 | 54.6 | 51.5 | 63.0 | 60.5 | 60.0 | 58.0 | 55.4 | 59.0 |
| Al₂O₃ (mol %) | 6.2 | 10.9 | 10.8 | 12.5 | 11.8 | 5.7 | 7.5 | 15.0 | 7.5 | 11.6 | 9.5 |
| B₂O₃ (mol %) | — | — | — | 0.5 | 1.0 | 1.0 | — | — | — | — | — |
| MgO (mol %) | 0.4 | 1.8 | — | 1.1 | 2.0 | — | — | — | 2.0 | 0.5 | — |
| CaO (mol %) | 0.4 | — | — | — | 2.0 | — | — | — | 0.0 | 1.2 | — |
| SrO (mol %) | 2.2 | 0.1 | — | 1.1 | — | — | — | — | 1.0 | 0.2 | — |
| BaO (mol %) | 0.0 | 1.9 | — | — | — | — | — | — | 1.0 | 2.0 | — |
| ZnO (mol %) | 12.4 | 8.0 | 14.6 | 12.6 | 12.8 | 12.4 | 11.0 | 5.0 | 11.0 | 5.1 | 9.0 |
| Na₂O (mol %) | 7.7 | 5.2 | 10.0 | 6.0 | 9.0 | 8.7 | 7.0 | 9.0 | 11.0 | 9.5 | 17.0 |
| K₂O (mol %) | 7.7 | 10.0 | 2.7 | 9.1 | 5.9 | 8.7 | 11.0 | 10.0 | 7.0 | 9.2 | 5.0 |
| Na₂O/K₂O | 1.0 | 0.5 | 3.7 | 0.7 | 1.5 | 1.0 | 0.6 | 0.9 | 1.6 | 1.0 | 3.4 |
| Na₂O + K₂O (mol %) | 15.4 | 15.2 | 12.7 | 15.1 | 14.9 | 17.4 | 18.0 | 19.0 | 18.0 | 18.7 | 22.0 |
| TiO₂ (mol %) | 0.6 | 1.9 | 2.3 | — | 2.1 | — | — | — | — | 2.5 | — |
| ZrO₂ (mol %) | 1.6 | 1.2 | 3.1 | 2.5 | 1.9 | 0.5 | 2.0 | 1.0 | 1.0 | 2.8 | 0.5 |
| CoO (mol %) | 0.5 | — | 1.5 | — | — | — | 1.0 | — | 0.5 | — | — |
| Expansion Ratio | 96.2 | 92.1 | 92.2 | 90.8 | 94.9 | 106.1 | 106.4 | 107.4 | 106.2 | 110.6 | 120.0 |
| (50° C.-650° C.) | | | | | | | | | | | |
| Yield Point (° C.) | 647 | 758 | 747 | 721 | 731 | 648 | 661 | 766 | 644 | 732 | 643 |
| Fusion-Bonding and Joining | Excel- | Excel- | Excel- | Good | Good | Excel- | Excel- | Excel- | Good | Excel- | Excel- |
| Properties to Metal | lent | lent | lent | | | lent | lent | lent | | lent | lent |
| Fusion-Bonding and Joining | Excel- | Excel- | Excel- | Good | Good | Excel- | Excel- | Excel- | Good | Excel- | Excel- |
| Properties to Ceramic | lent | lent | lent | | | lent | lent | lent | | lent | lent |
| Shape Stability up to | Excel- | Excel- | Excel- | Excel- | Good | Excel- | Excel- | Good | Excel- | Excel- | Excel- |
| 750° C. | lent | lent | lent | lent | | lent | lent | | lent | lent | lent |

TABLE 2

| | Comparative Examples | | | | | | | | | | | | | |
|---|---|---|---|---|---|---|---|---|---|---|---|---|---|---|
| | 1 | 2 | 3 | 4 | 5 | 6 | 7 | 8 | 9 | 10 | 11 | 12 | 13 | 14 |
| SiO₂ (mol %) | 66.2 | 51.7 | 64.0 | 39.3 | 56.0 | 75.0 | 55.0 | 55.0 | 65.0 | 66.0 | 50.0 | 62.0 | 55.4 | 55.4 |
| Al₂O₃ (mol %) | 1.4 | 4.6 | 8.0 | 0.7 | 6.5 | 5.0 | 25.0 | 10.0 | 15.0 | 15.0 | 5.0 | 10.0 | 11.6 | 11.6 |
| B₂O₃ (mol %) | — | 5.0 | — | 10.0 | 1.0 | — | — | — | — | — | — | — | — | — |
| MgO (mol %) | — | 7.5 | 5.0 | 25.4 | 2.0 | — | — | — | — | — | — | — | 0.5 | 0.5 |
| CaO (mol %) | — | — | — | — | 2.5 | — | — | — | — | — | — | — | 1.2 | 1.2 |
| SrO (mol %) | — | — | 5.0 | — | — | — | — | — | — | — | — | — | 0.2 | 0.2 |
| BaO (mol %) | — | 7.5 | — | 3.7 | — | — | — | — | — | — | — | — | 2.0 | 2.0 |
| ZnO (mol %) | 15.8 | 10.7 | 10.0 | 11.7 | 10.0 | 5.0 | 10.0 | 25.0 | 3.0 | 16.0 | 5.0 | 4.0 | 5.1 | 5.1 |
| Na₂O (mol %) | 8.3 | 7.0 | 4.0 | 5.0 | 6.0 | 7.5 | 5.0 | 5.0 | 8.5 | 0.5 | 30.0 | 10.0 | 9.5 | 9.5 |
| K₂O (mol %) | 8.3 | 6.0 | 4.0 | 4.2 | 10.0 | 7.5 | 5.0 | 5.0 | 8.5 | 2.5 | 10.0 | 9.0 | 9.2 | 9.2 |
| Na₂O/K₂O | 1.0 | 1.2 | 1.0 | 1.2 | 0.6 | 1.0 | 1.0 | 1.0 | 1.0 | 0.2 | 3.0 | 1.1 | 1.0 | 1.0 |
| Na₂O + K₂O | 16.6 | 13.0 | 8.0 | 9.2 | 16.0 | 15.0 | 10.0 | 10.0 | 17.0 | 3.0 | 40.0 | 19.0 | 18.7 | 18.7 |
| (mol %) | | | | | | | | | | | | | | |
| TiO₂ (mol %) | — | — | — | — | 3.5 | — | — | — | — | — | — | — | — | 5.3 |
| ZrO₂ (mol %) | — | — | — | — | 2.5 | — | — | — | — | — | — | — | 5.3 | — |
| CoO (mol %) | — | — | — | — | — | — | — | — | — | — | — | 5.0 | — | — |
| Expansion | 107.4 | 96.7 | 67.8 | 82.3 | 70.5 | 95.2 | 67.6 | 66.1 | 93.8 | 59.8 | 124.5 | 105.5 | 102.7 | 61.8 |
| Ratio | | | | | | | | | | | | | | |
| (50° C.-650° C.) | | | | | | | | | | | | | | |
| Yield Point | 614 | 599 | 734 | 620 | 727 | 672 | 797 | 711 | 790 | 797 | 660 | 660 | 782 | 725 |
| (° C.) | | | | | | | | | | | | | | |
| Fusion-Bonding | Excel- | Excel- | No | Excel- | No | No | Excel- | Excel- | No | No | Excel- | Excel- | Excel- | Excel- |
| and Joining | lent | lent | Good | lent | Good | Good | lent | lent | Good | Good | lent | lent | lent | lent |
| Properties to | | | | | | | | | | | | | | |
| Metal | | | | | | | | | | | | | | |
| Fusion-Bonding | Excel- | Excel- | No | Excel- | No | No | Excel- | Excel- | No | No | Excel- | Excel- | Excel- | Excel- |
| and Joining | lent | lent | Good | lent | Good | Good | lent | lent | Good | Good | lent | lent | lent | lent |
| Properties to | | | | | | | | | | | | | | |
| Ceramic | | | | | | | | | | | | | | |
| Shape Stability | No | No | Excel- | No | No | Excel- | No | No | No | Excel- | No | No | No | No |
| up to 750° C. | Good | Good | lent | Good | Good | lent | Good | Good | Good | lent | Good | Good | Good | Good |

Glass blocks of Examples 1 to 11 and Comparative Examples 1 to 14, prepared as described above, were evaluated in respect of the expansion ratio, the yield point, the fusion-bonding property with respect to the metal members and the ceramic members at 1000° C., and the shape stability.

The expansion ratio and the yield point were measured as follows: Parts of each glass block prepared were machined into a cylindrical shape having a diameter of 5 mm and a length of 18 mm, and used as samples for measuring the expansion ratio and the yield point. A thermal analysis apparatus “TAS-100” (TMA) available from Rigaku Co., Ltd. was used for the measurements. The measurements were performed in a temperature range of room temperature (50° C.) to a temperature close to the yield point (640° C.), and the rate of temperature rise was set to 5° C./minute.

The fusion-bonding property with respect to metal was evaluated as follows: Another part of the above glass block was pulverized in a mortar to thereby obtain powder whose particle diameter was controlled to 10 to 20 μm, as a sealing glass frit 21. Approximately 5 g of the sealing glass frit 21 was placed on a watch glass and formed into paste by adding methanol. Then, an appropriate amount of the paste-like glass frit 21 was filled in a ring 22 having a diameter of 10 mm which was placed on a stainless steel substrate 23 having a thickness of 1 mm and a length and a width of 30 mm, such that the height of the sealing glass frit 21 was 1 to 2 mm, and then dried. After the sealing glass frit 21 was sufficiently dried, the ring 22 was removed therefrom to thereby obtain a sample for fusion bonding test (FIG. 2). The sample was heated without further processing to 1000° C. at a temperature rise rate of 100 C/hour and held at 1000° C. for 10 hours, followed by being cooled to room temperature at 100° C./hour. After that, a check was made to determine whether or not the sample was fusion-bonded to the stainless steel substrate 23. More specifically, if a sample cooled to room temperature had undergone no separation from the stainless steel substrate 23, it was evaluated to be “Excellent”; if the same had undergone partial separation from the stainless steel substrate 23, it was evaluated to be “Good”; and if the same had undergone complete separation from the stainless steel substrate 23, it was evaluated to be “No Good”.

The joining property to metal was evaluated as follows: Two stainless steel substrates 23 were joined to each other using the above sealing glass frit 21 to thereby obtain a sample for testing the joining property. The temperature of the sample was varied without further processing between room temperature and 750° C., and a check was made to determine whether or not the stainless steel substrates 23 joined to each other had undergone separation. More specifically, if a sample cooled to room temperature had undergone no separation from the stainless steel substrate 23, it was evaluated to be “Excellent”; if the same had undergone partial separation from the stainless steel substrate 23, it was evaluated to be “Good”; and if the same had undergone complete separation from the stainless steel substrate 23, it was evaluated to be “No Good”.

Further, the fusion-bonding property with respect to the ceramic members and the joining property to the same were evaluated by the same method as described above, except that a ceramic substrate made of alumina was used in place of the stainless steel substrate 23.

The shape stability was evaluated as follows: Cubic blocks having a size of approximately 5 mm square were cut out from the glass blocks described above to thereby obtain samples for evaluating the shape stability. Each sample, placed on the alumina substrate, was put into an electric furnace, and then heated to 750° C. at a temperature rise rate of 100 C/hour. After being held at 750° C. for 48 hours, the sample was cooled to room temperature at 100° C./hour. Each sample subjected to the thermal treatment described above was inspected to determine whether or not it had undergone deformation or devitrification. More specifically, if a sample cooled to room temperature had undergone no deformation or devitrification, it was evaluated to be “Excellent”; if the same had partially undergone deformation or devitrification, it was evaluated to be “Good”; and if the same in its entirety had undergone deformation or devitrification, it was evaluated to be “No Good”.

The evaluation results concerning the expansion ratio, the yield point, the fusion-bonding property with respect to the metal members and the ceramic members at 1000° C., the joining property, and the shape stability are shown in Table 1 and Table 2.

As shown in Example 4 in Table 1, when the components of MgO, CaO, SrO, and BaO were added to the glass frit such that the total content thereof was not higher than 5 mol %, it was possible to lower the fusion-bonding temperature of the glass frit while maintaining rigidity thereof at 700 to 800° C., and the fusion-bonding property with respect to the metal members and the ceramic members and the shape stability at 750° C. were improved. Further, as shown in Example 4 in Table 1, when the components of MgO, CaO, SrO, and BaO were added to the glass frit such that the total content thereof was not higher than 4 mol %, devitrification was difficult to occur at temperatures ranging from room temperature to 700 or 800° C.

When Li₂O was added to the glass frit having a composition set forth in Example 5 in Table 1 such that the content thereof was not higher than 5 mol %, the adjustment of the expansion ratio and the fusion-bonding temperature using Na₂O and K₂O could be performed more positively, so that the fusion-bonding property with respect to the metal members and the ceramic members and the shape stability at 750° C. were both improved. However, when Li₂O was added to the glass frit until the content thereof exceeded 5 mol %, it becomes impossible to maintain the rigidity at 800° C. and temperatures close thereto, resulting in reduced shape stability.

As shown in Example 11 in Table 1, when the mol % ratio of Na₂O to K₂O, as components of the glass frit, is in a range of 2.0 to 4.0, K₂CrO₄ is difficult to be generated even when K₂O reacts with Cr in the metal members. The melting point of K₂CrO₄ is 975° C. and hence higher than 800° C., so that there is an increased possibility of a joined portion separating due to generation of K₂CrO₄.

The shape stability is low in Comparative Example 1, because when the yield point is as low as 614° C., and further the Al₂O₃ content is as small as 1.4 mol %, it is impossible to obtain sufficient rigidity at 750° C. or temperatures close thereto.

The shape stability is low in Comparative Example 2, because when the yield point is as low as 599° C., and the Al₂O₃ content is as small as 4.6 mol %, it is impossible to obtain sufficient rigidity at 750° C. or temperatures close thereto.

The fusion-bonding property and the joining property are low in Comparative Example 3, because when the total content of Na₂O and K₂O is as small as 8.0 mol %, it is impossible to maintain an expansion ratio of not smaller than 90×10⁻⁷/° C. at temperatures ranging from room temperature to 750° C., and when a large area is sealed, it is difficult to stably maintain the sealed state of the area due to occurrence of variation in the expansion ratio.

The shape stability is low in Comparative Example 4, for the following reasons: SiO₂ is a main component for manufacturing glass, and when the SiO₂ content is as small as 39.3 mol %, vitrification does not occur; the sealing glass frit has a low yield point of 620° C., so that it is impossible to maintain the rigidity of the sealing glass frit in the temperature range of 700 to 800° C.; the content of Al₂O₃ is as small as 0.7 mol %, so that it is impossible to maintain the rigidity of the sealing glass frit at 750° C. or temperatures close thereto; when the content of B₂O₃ is as large as 10 mol %, it is impossible to maintain the shape stability when the sealing glass frit is held at 700 to 800° C.; and further when the total content of Na₂O and K₂O is as small as 9.2 mol %, it is impossible to maintain an expansion ratio of not smaller than 90×10⁻⁷/° C. at temperatures ranging from room temperature to 750 or 800° C.

The fusion-bonding property, the joining property, and the shape stability are all low in Comparative Example 5, because the total content of MgO and CaO is higher than 4 mol %, and devitrification at temperatures ranging from room temperature to 700 or 800° C. is liable to occur, so that a joined portion readily separates due to occurrence of a change in volume thereof.

The fusion-bonding property and the joining property are low in Comparative Example 6, because the SiO₂ content is as large as 75 mol %, so that it is impossible to perform sufficient fusion bonding even at 1100° C.

The shape stability is low in Comparative Example 7, because when the Al₂O₃ content is as large as 25 mol %, devitrification is liable to occur during fusion bonding, so that a joined portion readily separates due to occurrence of a change in volume thereof.

The shape stability is low in Comparative Example 8, because when the ZnO content is as large as 25 mol %, devitrification is liable to occur during fusion bonding.

There is no shape stability or fusion-bonding property in Comparative Example 9, because when ZnO is contained in an amount as small as 3 mol %, it is impossible to exhibit the effect of lowering the fusion-bonding temperature while maintaining the rigidity at 750° C.

The fusion-bonding property is low in Comparative Example 10, because when the Na₂O content is as small as 0.5 mol %, and the total content of Na₂O and K₂O is as small as 4 mol %, the expansion ratio is smaller than 90×10⁻⁷/° C. at temperatures from room temperature to 750 or 800° C., so that fusion bonding of the sealing glass frit to the metal members and the ceramic members cannot be sufficiently performed even at 1100° C. or temperatures close thereto. Further, the shape stability is low in Comparative Example 10, because when the mol % ratio of Na₂O to K₂O is as low as 0.2, devitrification is liable to occur.

The shape stability is low in Comparative Example 11, because when the Na₂O content is as large as 30 mol %, it is impossible to maintain the rigidity at 800° C., and further when the mol % ratio of Na₂O to K₂O is as high as 3.0, devitrification is liable to occur.

The shape stability is low in Comparative Example 12, because the amount of CoO added is as large as 5 mol %, devitrification is liable to occur during fusion bonding.

The shape stability is low in Comparative Example 13, because ZrO₂, which has the effect of lowering the fusion-bonding temperature while maintaining the rigidity at 700 to 800° C., is not contained at all, so that the effect of ZrO₂ is not exhibited, whereas when the ZrO₂ content is as large as 5.3 mol %, devitrification is liable to occur during fusion bonding.

The shape stability is low in Comparative Example 14, because when the TiO₂ content is as large as 5.3 mol %, the expansion ratio is smaller than 90×10⁻¹⁷/° C., and further devitrification is liable to occur during fusion bonding.

From the results of Examples 1 to 11, and Comparative Examples 1 to 14 shown in Table 1 and Table 2, the following facts were found.

The sealing glass frit comprises, as essential components, SiO₂: 40 to 70 mol %, Al₂O₃: 5 to 20 mol %, Na₂O: 4 to 20 mol %, K₂O: 4 to 20 mol %, ZnO: 5 to 20 mol %, and ZrO₂: 0.5 to 5 mol %, and the total content of Na₂O and K₂O is not lower than 12 mol %. As a result, the viscosity of the sealing glass frit at 1000° C. can be made not higher than 10000 P which is suitable for fusion bonding. This makes it possible to stably join the metal members and the ceramic members at temperatures not higher than 1000° C. Further, the sealing glass frit having the above composition has a mean expansion ratio of not smaller than 90×10⁻⁷/° C. at temperatures ranging from room temperature to a temperature lower than the transition point by 30° C. so that the expansion ratio of the sealing glass frit is close to those of the metal members and the ceramic members, whereby it is possible to stably maintain the joined state of the metal members and the ceramic members at temperatures not higher than 700 to 800° C.

Preferably, when the mol % ratio of Na₂O to K₂O is in a range of 0.5 to 2.0, devitrification can be made difficult to occur. More preferably, when the total content of Na₂O and K₂O is not lower than 15.5 mol %, the sealing glass frit has a mean expansion ratio of not smaller than 90×10⁻⁷/° C. at temperatures ranging from room temperature to a temperature lower than the transition point by 30° C. so that the expansion ratio of the sealing glass frit is closer to those of the metal members and the ceramic members, whereby it is possible to more stably maintain the joined state of the metal members and the ceramic members at temperatures not higher than 700 to 800° C.

Further, when Li₂O: 0 to 5 mol %, MgO: 0 to 5 mol %, CaO: 0 to 5 mol %, SrO: 0 to 5 mol %, BaO: 0 to 5 mol %, TiO₂: 0 to 5 mol %, B₂O₃: 0 to 5 mol %, and CoO: 0 to 5 mol % are added to glass containing the above-mentioned essential components such that the total content thereof is not higher than 10 mol %, it is possible to lower the fusion-bonding temperature of the sealing glass frit while maintaining rigidity thereof at temperatures up to 700 or 800° C., and when the total content of MgO, CaO, SrO, and BaO is not higher than 4 mol %, it is possible to make devitrification difficult to occur at temperatures ranging from room temperature to 700 or 800° C.

Furthermore, when the temperature of the sealing glass frit at the yield point is not lower than 640° C., the sealing glass frit can maintain rigidity thereof in the temperature range of 700 to 800° C. Further, when 0.1 to 10 mass % of at least one material selected from the group consisting of alumina, cordierite, silica, zircon, aluminum titanate, forsterite, mullite, β-eucryptite, and β-spodumene is added as a filler, it is possible to properly adjust the expansion ratio of the sealing glass frit.

### INDUSTRIAL APPLICABILITY

As described in detail heretofore, according to the sealing glass frit of the present invention, the sealing glass frit comprises, as essential components, SiO₂: 40 to 70 mol %, Al₂O₃: 5 to 20 mol %, Na₂O: 4 to 20 mol %, K₂O: 4 to 20 mol %, ZnO: 5 to 20 mol %, and ZrO₂: 0.5 to 5 mol %, and the total content of Na₂O and K₂O is not lower than 12 mol %. As a result, the viscosity of the sealing glass frit at 1000° C. can be made not higher than 10000 P which is suitable for fusion bonding. This makes it possible to stably join metal members and ceramic members at temperatures not higher than 1000° C. Further, the sealing glass frit having the above composition has a mean expansion ratio of not smaller than 90×10⁻⁷/° C. at temperatures ranging from room temperature to a temperature lower than the transition point by 30° C. so that the expansion ratio of the sealing glass frit is close to those of the metal members and the ceramic members, whereby it is possible to stably maintain the joined state of the metal members and the ceramic members at temperatures ranging from room temperature to 700 or 800° C.

According to the sealing glass frit of the present embodiment, the components thereof are SiO₂: 55 to 65 mol %, Al₂O₃: 5 to 12 mol %, Na₂O: 4 to 20 mol %, K₂O: 4 to 20 mol %, ZnO: 5 to 15 mol %, ZrO₂: 0.5 to 3 mol %, and CoO: 0 to 3 mol %, and the total content of Na₂O and K₂O is not lower than 15 mol %. As a result, it is possible to maintain a stable joined state even if the sealing glass frit is held at 700 to 800° C.

According to the sealing glass frit of the present embodiment, Li₂O: 0 to 5 mol %, MgO: 0 to 5 mol %, CaO: 0 to 5 mol %, SrO: 0 to 5 mol %, BaO: 0 to 5 mol %, TiO₂: 0 to 5 mol %, B₂O₃: 0 to 5 mol %, and CoO: 0 to 5 mol % are added to the essential components of the sealing glass frit such that the total content thereof is not higher than 10 mol %. As a result, it is possible to lower the fusion-bonding temperature of the sealing glass frit while maintaining rigidity thereof at temperatures up to 700 to 800° C.

According to the sealing glass frit of the present embodiment, when the total content of MgO, CaO, SrO, and BaO as components of the sealing glass frit is not higher than 4 mol %, it is possible to make devitrification difficult to occur at temperatures ranging from room temperature to 700 or 800° C.

According to the sealing glass frit of the present embodiment, when the mol % ratio of Na₂O to K₂O, as components of the sealing glass frit, is in a range of 2.0 to 4.0, K₂CrO₄ is difficult to be generated even when K₂O reacts with Cr in the metal members. This makes it possible to prevent the joined portion from separating due to generation of K₂CrO₄.

According to the sealing glass frit of the present embodiment, when the mol % ratio of Na₂O to K₂O, as components of the sealing glass frit, is in a range of 0.5 to 2.0, it is possible to make devitrification difficult to occur.

According to the sealing glass frit of the present embodiment, when the total content of Na₂O and K₂O, as components of the sealing glass frit, is not lower than 15.5 mol %, the sealing glass frit has a mean expansion ratio of not smaller than 90×10⁻⁷/° C. at temperatures ranging from room temperature to a temperature lower than the transition point by 30° C. so that the expansion ratio of the sealing glass frit is closer to those of the metal members and the ceramic members, whereby it is possible to more stably maintain the joined state of the metal members and the ceramic members at temperatures not higher than 700 to 800° C.

According to the sealing glass frit of the present embodiment, when the temperature of the sealing glass frit at the yield point is not lower than 640° C., the sealing glass frit can maintain rigidity thereof in the temperature range of 700 to 800° C.

According to the sealing glass frit of the present embodiment, when 0.1 to 10 mass % of at least one material selected from the group consisting of alumina, cordierite, silica, zircon, aluminum titanate, forsterite, mullite, β-eucryptite, and β-spodumene is added to the aforementioned components as a filler, it is possible to properly adjust the expansion ratio of the sealing glass frit.

According to the sealing glass frit of the present embodiment, since it is used to join a cathode, a separator, and an anode, as components of a solid oxide fuel cell, to each other, it is possible to increase the service life of the solid oxide fuel cell.

1. A sealing glass frit for joining metal members or ceramic members, comprising, as essential components, SiO₂: 40 to 70 mol %, Al₂O₃: 5 to 20 mol %, Na₂O: 4 to 20 mol %, K₂O: 4 to 20 mol %, ZnO: 5 to 20 mol %, and ZrO₂: 0.5 to 5 mol %, and wherein a total content of Na₂O and K₂O is not lower than 12 mol %.

2. A sealing glass frit as claimed in claim 1, comprising SiO₂: 55 to 65 mol %, Al₂O₃: 5 to 12 mol %, Na₂O: 4 to 20 mol %, K₂O: 4 to 20 mol %, ZnO: 5 to 15 mol %, ZrO₂: 0.5 to 3 mol %, and CoO: 0 to 3 mol %, and
wherein the total content of Na₂O and K₂O is not lower than 15 mol %.

3. A sealing glass frit as claimed in claim 1, wherein Li₂O: 0 to 5 mol %, MgO: 0 to 5 mol %, CaO: 0 to 5 mol %, SrO: 0 to 5 mol %, BaO: 0 to 5 mol %, TiO₂: 0 to 5 mol %, B₂O₃: 0 to 5 mol %, and CoO: 0 to 5 mol % are added to the essential components such that a total content thereof is not higher than 10 mol %.

4. A sealing glass frit as claimed in claim 3, wherein a total content of MgO, CaO, SrO, and BaO is not higher than 4 mol %.

5. A sealing glass frit as claimed in claim 1, wherein a mol % ratio of Na₂O to K₂O is in a range of 2.0 to 4.0.

6. A sealing glass frit as claimed in claim 1, wherein a mol % ratio of Na₂O to K₂O is in a range of 0.5 to 2.0.

7. A sealing glass frit as claimed in claim 1, wherein the total content of Na₂O and K₂O is not lower than 15.5 mol %.

8. A sealing glass frit as claimed in claim 1, wherein a temperature thereof at a yield point thereof is not lower than 640° C.

9. A sealing glass frit as claimed in claim 1, wherein 0.1 to 10 mass % of at least one material selected from the group consisting of alumina, cordierite, silica, zircon, aluminum titanate, forsterite, mullite, β-eucryptite, and β-spodumene is added as a filler.

10. A sealing glass frit as claimed in claim 1, wherein the sealing glass frit is used to join a cathode, a separator, and an anode, as components of a solid oxide fuel cell, to each other.
